(19) United States
(12) Patent Application Publication
(10) Pub. No.: US 2003/0020935 A1
(43) Pub. Date: Jan. 30, 2003

(54) Image processing method and apparatus

(76) Inventor: Hiroyuki Morimatsu, Kurume-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/201,630

(22) Filed: Jul. 24, 2002

(30) Foreign Application Priority Data
Jul. 27, 2001 (JP) 2001-227436

(51) Int. Cl. H04N 1/52

(52) U.S. Cl. 358/1.9; 358/534; 358/536

(57) ABSTRACT

Dots defining the number of screen lines, of at least one color component of a plurality of color components, which number is different from that defined for each of other color components are generated on the basis of the screen method in which dot shape after binarization defines a halftone dot. A printing method and apparatus for generating binary data so that the size of such dots arranged concentrated to determine the number of screen lines differs among image constituting color components in the image after the binarization.

### BACKGROUND OF THE INVENTION

1. Field of the Invention

The present invention relates to an image processing method and apparatus, applied to printers, scanners, copying machines, facsimiles or the like, for reproducing multivalued color image information in the form of binary images.

2. Description of the Related Art

Heretofore, as one of methods of converting a multi-gradation image into a binary image, there is the binarization method based on the screen method. Now, the description will hereinbelow be given with respect to a binarization apparatus based on the conventional screen method.

FIG. 7 is a block diagram showing a configuration of a conventional binarization apparatus based on the screen method, and FIG. 8 is a diagram showing one example of a threshold matrix.

The conventional binarization apparatus will now be schematically described with reference to FIG. 7. In the figure, image data 1 is multivalued original image data becoming an object of binarization. Normally, such data to be binarized for a printing machine is image data having color components of four colors, i.e., Black, Cyanogen, Magenta and Yellow. In addition, a threshold matrix as a table of thresholds as shown in FIG. 8 is stored in a threshold matrix storing unit 3. This is one example of a threshold matrix which is used when the concentration or density level of the image data 1 has 256 gradations ranging from 0 to 255. Heretofore, this matrix data has been designed in such a way that dots are regularly arranged under a certain generation rule. A comparator 2 receives as its input D, from the image data 1, as density data of each of pixels of each of color components in the image data, and receives threshold data T, from the threshold matrix storing unit 3, corresponding to the coordinates of the acquired image data. Then, the comparator 2 compares the pixel image data D with the threshold data T. If D>T, then a binary signal is outputted with a binarization result Q as 1, i.e., with dot being made ON. On the other hand, if D<T, then a binary signal is outputted with a binarization result as 0, i.e., with dot being made OFF. Such processing is executed for all of the pixels of the color components constituting the image data, whereby the binary image data is finally generated. The binary data thus generated becomes a state, in which dots are concentratedly arranged, referred to as “a halftone dot”. Normally, how many halftone dots are formed per inch is referred to as “the number of screen lines”.

In the binary image generated on the basis of the screen method as the prior art, normally, dots having the sahalftoneape are generated in a plurality of color components constituting an image. However, in the case where the printing property and the like, in a printing machine, of a plurality of color components constituting an image are taken into consideration, it is conceivable that the better printing image is formed when the shapes of dots are optimized in correspondence to the printing property of the respective color components rather than the same configuration of dots being set with respect to a plurality of color components constituting an image. That is, in order to improve the printing picture quality in a printing machine or the like, it is required that each of the color components is given the optimized dot configuration rather than the color components are given the same dot configuration as in the screen method known as the conventional method.

### SUMMARY OF THE INVENTION

In the light of the foregoing, it is therefore an object of the present invention to improve the problems occurring in the screen method as the above-mentioned prior art.

In order to solve the above-mentioned problems, the idea of the present invention may provide that in a binarization processing for an image constituted by a plurality of color components, dots in which the number of screen lines of at least one color component in a plurality of color components is different from each of the numbers of screen lines constituting other color components are generated on the basis of the screen method in which the shapes of the dots after completion of the binarization processing constitute the halftone dots. That is to say, the binary data is generated so that the size of the dots arranged concentrated to determine the number of screen lines differs among the color components constituting an image after completion of the binarization processing.

The first aspect of the present invention may provide an image processing method for execution of a binarization processing, for an image, of generating a binary image through a pseudo-half-tone processing, wherein the image generated after completion of the binarization processing becomes of screen configuration having halftone dot configuration, and the number of screen lines of at least one color component in a plurality of color components constituting the image after completion of the binarization is different from that of each of other colors. As a result, the number of screen lines optimal for the printing property, in a printing machine, of a plurality of color components constituting an image can be applied to each of constituent colors. Consequently, the printing is further stabilized and hence it is possible to improve the printing quality.

A second aspect of the invention provides, in the first aspect, that the number of screen lines of the color component which is different from that of each of other color components in a plurality of color components has a period in a main scanning direction which is equal to that of the number of screen lines of each of other color components. As a result, since the periods of dots generated in the main scanning direction become equal to each other between them, it is possible to suppress generation of Moire. In addition, since the size of dots optimal for the constituent colors can be set in the sub-scanning direction, the printing is further stabilized and hence it is possible to generate the binary data of high picture quality in which the generation of Moire is suppressed.

A third aspect of the invention provides, in the firs aspect, that the number of screen lines of the color component which is different from that of each of other color components in a plurality of color components has a period in a sub-scanning direction which period is equal to that of the number of screen lines of each of other color components. As a result, since the periods of dots generated in the sub-scanning direction become equal to each other between them, it is possible to suppress the generation of Moire. In addition, since the size of dots optimal for the constituent colors can be set in the main scanning direction, the printing is further stabilized and hence it is possible to generate binary data of high picture quality in which the generation of Moire is suppressed.

A fourth aspect of the invention provides, in the first aspect, that the number of screen lines of the color component which is different from that of each of other color components in a plurality of color components has screen periods in both a main scanning and sub-scanning directions which are double those of the number of screen lines of each of the other color components. Thus, since the screen periods in both the main scanning and sub-scanning directions become the double periods, it is possible to suppress the generation of Moire, and with respect to the color component constituted by the number of screen lines having the double periods, it is possible to generate stably the printing data.

A fifth aspect of the invention provides, in the second aspect, that a threshold matrix used to generate a screen of the color component having the number of screen lines different from that of each of other colors in a plurality of color components is produced by enlarging twice each of threshold matrixes, used to generate screens of other color components, in a sub-scanning direction through a simple interpolation. Thus, this threshold matrix is applied to execute the binarization processing, whereby it is possible to generate a dot which is enlarged twice in the sub-scanning direction.

A sixth aspect of the invention provides, in the third aspect, that a threshold matrix used to generate a screen of the color component having the number of screen lines which is different from that of each of other color components in a plurality of color components is generated by enlarging twice each of threshold matrixes, used to generate screens of other components, in a main scanning direction through the simple interpolation. Thus, this threshold matrix is applied to execute the binarization processing, whereby it is possible to generate a dot which is enlarged twice in the main scanning direction.

A seventh aspect of the invention provides, in the fourth aspect, that a threshold matrix used to generate a screen of the color component having the number of screen lines which is different from that of each of other colors in a plurality of color components is produced by enlarging twice a threshold matrix, used to generate screens of other color components, in both a main scanning and sub-scanning directions through the simple interpolation. As a result, in the color component having the number of screen lines which is different from that of each of other color components, it becomes possible to generate a dot which is enlarged twice in both the main scanning and sub-scanning directions.

### BRIEF DESCRIPTION OF THE DRAWINGS

FIG. 1 is a block diagram showing an arrangement of an image processing apparatus employing an image processing method according to one embodiment of the present invention.

FIG. 2 is a flow chart useful in explaining the operation of the image processing apparatus employing the image processing method according to one embodiment of the present invention.

FIG. 3 is a diagram showing dot arrangement after completion of the binarization of color components of the present invention;

FIG. 4 is a diagram showing a first example of a threshold matrix used to carry out dot output at a 25% density of Cyanogen and Yellow of the present invention;

FIG. 5 is a diagram showing a second example of a dot output of Yellow and a threshold matrix of the present invention;

FIG. 6 is a diagram showing a third example of a dot output of Yellow and a threshold matrix of the present invention;

FIG. 7 is a block diagram showing an arrangement of a conventional binarization apparatus; and

FIG. 8 is a diagram showing one example of a conventional threshold matrix.

### DESCRIPTION OF THE EMBODIMENTS

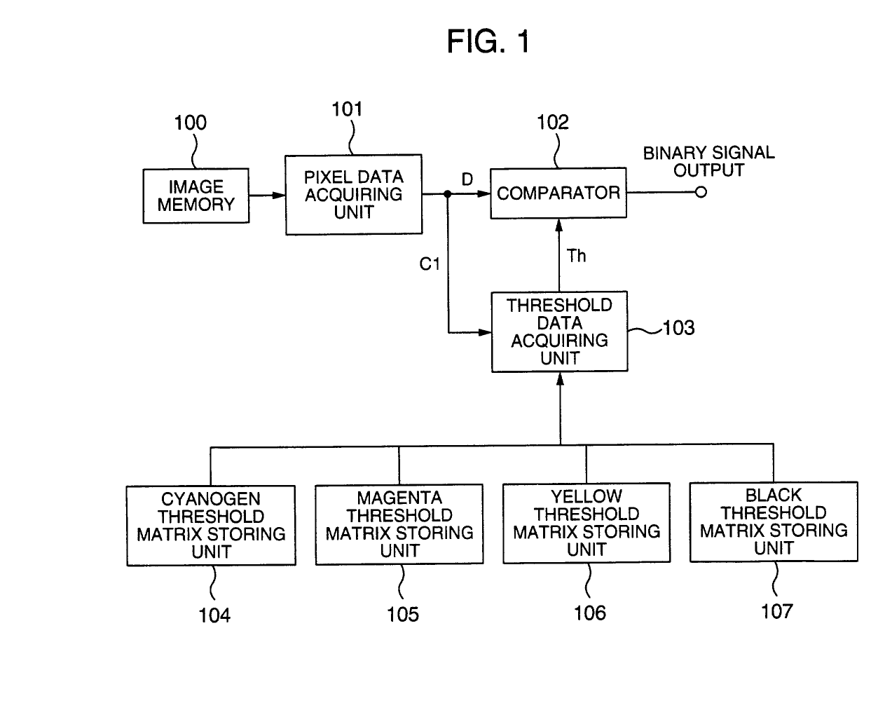

The preferred embodiment of the present invention will hereinafter be described in detail with reference to the accompanying drawings. By the way, in the present embodiment, the description will hereinbelow be given with respect to the case where image data becoming an object of the binarization processing is constituted by four color components, i.e., Cyanogen, Magenta, Yellow and Black. FIG. 1 is a block diagram showing a configuration of an image processing apparatus employing an image processing method according to one embodiment of the present invention.

In FIG. 1, reference numeral 100 designates a memory for storing therein multivalued image data to be processed. The image data stored in the image memory 100 is outputted in pixels to a pixel data acquiring unit 101. The pixel data acquiring unit 101 acquires data in pixels from and by scanning, in main (e.g., horizontal) and sub (e.g., vertical scanning directions, the image data stored in the image memory 100 to output the data to a comparator 102. The comparator 102 receives as its input the data in the pixels from the pixel data acquiring unit 101 and compares the image data outputted from the image data acquiring unit 101 with threshold data acquired by a threshold data acquiring unit 103 to output a binarization result. The threshold data acquiring unit 103, on the basis of addresses of the image data outputted from the pixel data acquiring unit 101 and color information becoming an object of the processing, acquires corresponding threshold data stored in any one of a Cyanogen threshold matrix storing unit 104, a Magenta threshold matrix storing unit 105, a Yellow threshold matrix storing unit 106, and a Black threshold matrix storing unit 107 in order to output the corresponding threshold data to the comparator 102.

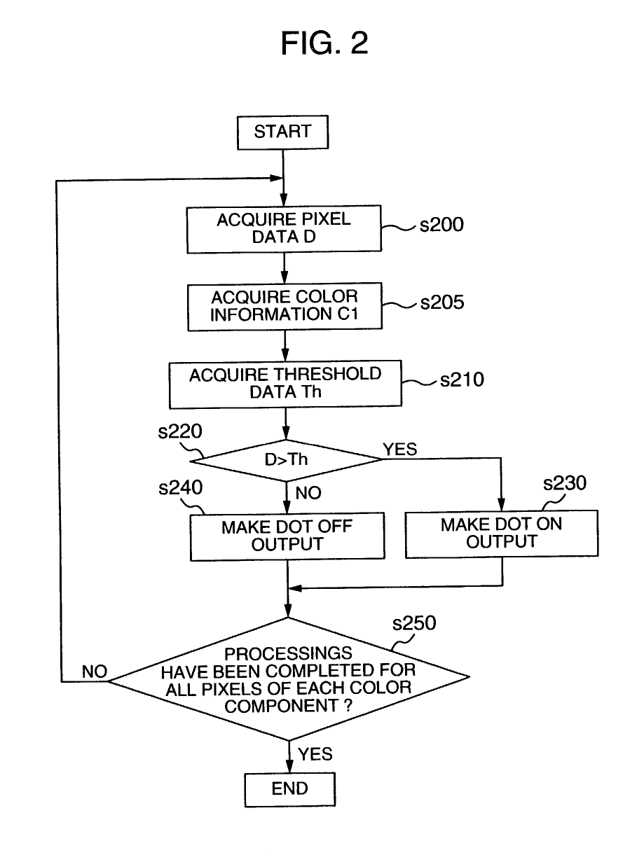

The description will hereinbelow be given with respect to the operation of the image processing apparatus employing an image processing method and configured as described above with reference to a flow chart shown in FIG. 2.

First of all, data D in pixels is acquired from the image data stored in the image memory 100 by the pixel data acquiring unit 101 (Step 200), and then color component information C1 becoming an object of the processing is acquired (Step 205). Now, the color component information C1 is any one of C, M, Y, and K. A threshold corresponding to the acquired pixel is acquired from any one of the Cyanogen threshold matrix storing unit 104, the Magenta threshold matrix storing unit 105, the Yellow threshold matrix storing unit 106, and the Black threshold matrix storing unit 107 (Step 210). By the way, a unit for generating threshold data stored in each of the threshold matrix storing units will be described later. Then, the pixel data D thus acquired is compared with threshold data Th in the comparator 102 (Step 220). If D>Th, then dot(s) is made ON to output the binarized data (Step 230). On the other hand, if D<Th, then dot(s) is made OFF to output the binarized data (Step 240). The above-mentioned processings are executed for all of the pixels of each of the color components of the inputted image data to complete the process (Step 250).

Next, the description will hereinbelow be given with respect to the threshold matrixes which are respectively stored in the Cyanogen threshold matrix storing unit 104, the Magenta threshold matrix storing unit 105, the Yellow threshold matrix storing unit 106 and the black threshold matrix storing unit 107.

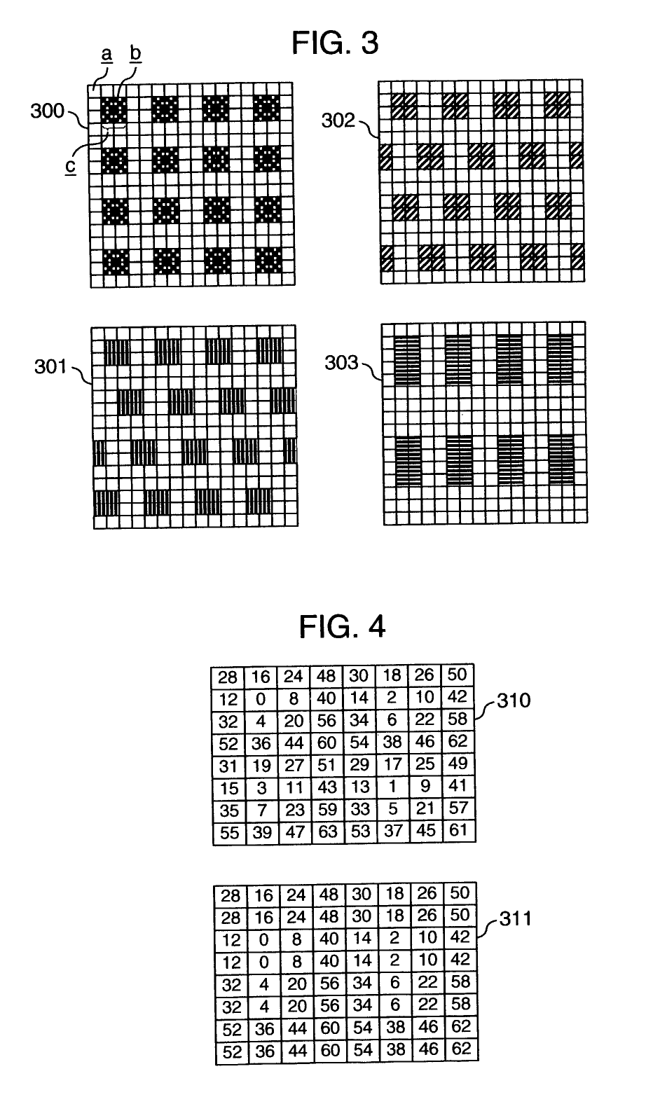

First of all, the description will hereinbelow be given with respect to a first example of the threshold matrixes of the color components with reference to FIG. 3. FIG. 3 is a diagram showing a dot arrangement, at a density of 25%, after completion of the binarization of each color component. In FIG. 3, reference numeral 300 designates a binarized output as a result of employing the threshold stored in the Cyanogen threshold matrix storing unit 104, and also the dot output in the case of a density is 25%. Reference numeral 301 designates a binarized output, at a density of 25%, employing the threshold stored in the Magenta threshold matrix storing unit 105, reference numeral 302 designates a binarized output, at a density of 25%, employing the threshold stored in the Black threshold matrix storing unit 107, and reference numeral 303 designates a binarized output, at a density of 25%, employing the threshold stored in the Yellow threshold matrix storing unit 106. Herein, taking binarized output 300 in FIG. 3 as an example for sake of explanation convenience (without intention of limitation), it may be said that a blank square designated by reference mark a represents one dot, a square of black thick portion designated by mark b represents one dot, four (2×2=4) dots designated by mark c form a halftone dot, binarized output 300 comprises sixteen (4×4=16) halftone dots, and that assuming one inch as a one side length of a square showing the binarized output 300, the number of screen lines of the binarized output 300 is given as “4”. From the Figure, it is understood that in the result of the binarized output 303, at the density of 25%, employing the threshold stored in the Yellow threshold matrix storing unit 106, the period of outputting dots in a sub-scanning direction, i.e., the number of screen lines in the sub-scanning direction is doubled as compared with the binarization results of other color components. In addition, the dot periods of the color components in a main scanning direction are equal to one another among them.

Next, the description will hereinbelow be given with respect to configuration of the threshold matrixes used to carry out the above-mentioned dot arrangement. FIG. 4 is one example of the threshold matrixes used to carry out the dot outputs for Cyanogen and Yellow. In FIG. 4, reference numeral 310 designates the threshold matrix, as one example, stored in the cyanogen threshold matrix storing unit 104, and reference numeral 311 designates the threshold matrix, as one example, stored in the Yellow threshold matrix storing unit 106. By the way, the output level of an image is in the range of 0 to 63. The Cyanogen threshold matrix 310 can be readily produced using the existing technique such as Bayer's method, and also with respect to Magenta and Black as well, the threshold matrixes can be generated using the same technique. The Yellow threshold matrix 311 is obtained by enlarging twice the Cyanogen threshold matrix 310 in the sub-scanning direction through the simple interpolation method. Then, this threshold matrix is applied to Yellow, whereby it becomes possible to output dots having the period which is doubled in the scanning direction. Herein the simple interpolation method is intended as an interpolation method of inserting, to give necessary (or interpolated) values, a matrix raw (or column) of threshold values repeatedly plural times which values are same as those values of the just preceding raw (or column), for example, as shown in the matrix 311.

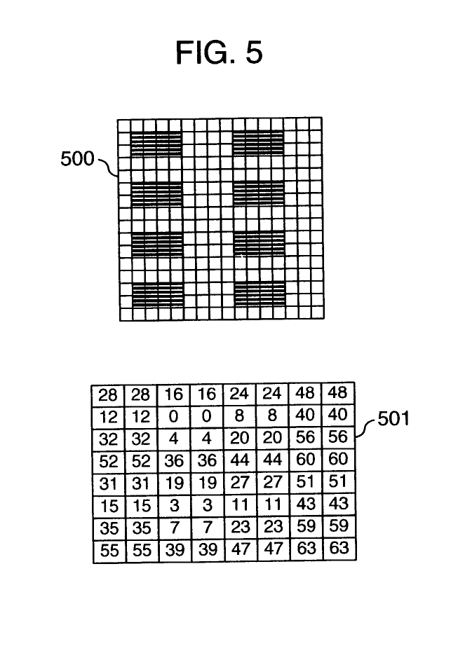

Next, the description will hereinbelow be given with respect to a second example of the Yellow threshold matrix with reference to FIG. 5. In FIG. 5, reference numeral 500 designates a binarized output, at a density of 25%, employing the threshold stored in the Yellow threshold table 106. From the figure, it is understood that in the result of the binarized output 500, at a density of 25%, employing the threshold stored in the Yellow threshold matrix storing unit 106, the output period of dots in a main scanning direction, i.e., the number of screen lines in the main scanning direction has the period which is double those of the binarization results of other color components. In addition, the dot periods in a sub-scanning direction are equal to one another among them.

In FIG. 5, reference numeral 501 designates a second example of the threshold matrix stored in the Yellow threshold matrix storing unit 106. By the way, the output level of an image is in the range of 0 to 63. The Yellow threshold matrix 501 is obtained by enlarging twice the Cyanogen threshold matrix 310 in the main scanning direction through the simple interpolation method. Then, this threshold matrix is applied to Yellow, whereby it becomes possible to output of dots having the period which is doubled in the main scanning direction.

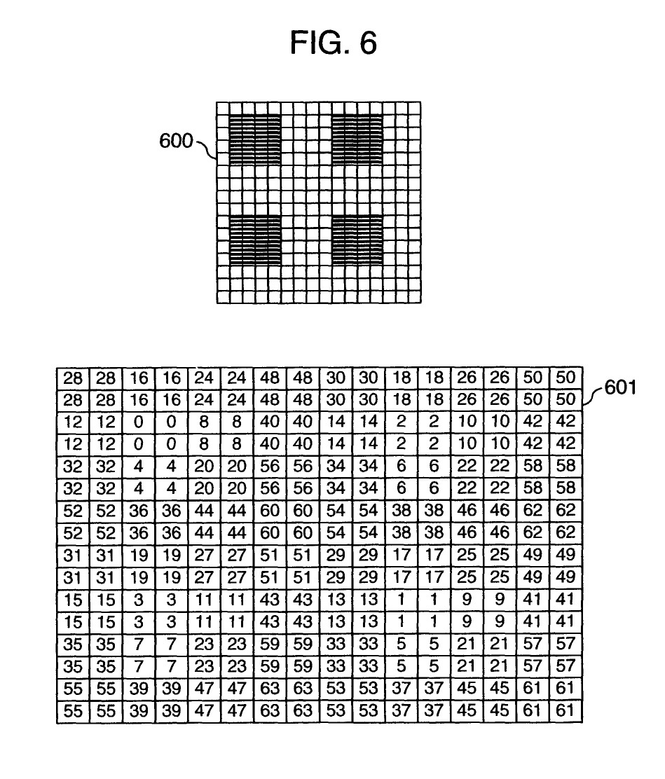

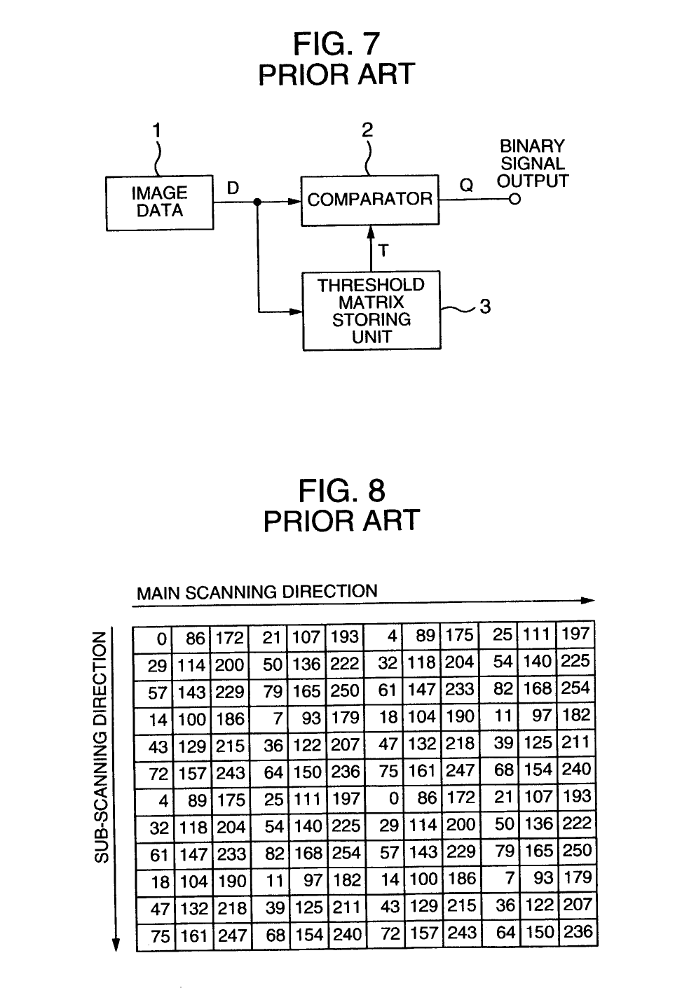

Next, the description will hereinbelow be given with respect to a third example of the Yellow threshold matrix with reference to FIG. 6. In FIG. 6, reference numeral 600 designates a binarized output, at density of 25%, employing the threshold stored in the Yellow threshold table 106. From the Figure, it is understood that in the result of the binarized output 600, at density of 25%, employing the threshold stored in the Yellow threshold table 106, the dot output periods in both the main scanning and sub-scanning directions, i.e., the numbers of screen lines in both the main scanning and sub-scanning directions have respectively the periods which are double those of the binarization results of other color components.

In FIG. 6, reference numeral 601 designates a third example of the threshold matrix stored in the Yellow threshold matrix storing unit 106. By the way, the input level of an image is in the range of 0 to 63. The Yellow threshold matrix 601 is obtained by enlarging twice the Cyanogen threshold matrix 310 in both the main scanning and sub-scanning directions through the simple interpolation method. Then, this threshold matrix is applied to Yellow, whereby it becomes possible to output dots each having the period which is doubled in both the main scanning and sub-scanning directions.

While in the present embodiment, the screen period of Yellow is doubled in both the main scanning and sub-scanning directions, as a matter of course, it is also conceivable to apply any of the periods other than the double period. In addition, while the threshold matrix is enlarged through the simple interpolation method, it is to be understood that it is possible to generate threshold matrixes having different periods through any of other interpolation methods, or another method. Further, while in the present embodiment, the description has been given with respect to the case where only the period of Yellow is made different from that of each of other color components, as a matter of course, it is also conceivable to apply the numbers of screen lines having different periods to other color components.

As described above, according to the present embodiment, the number of screen lines of Yellow is made smaller than that of each of Cyanogen, Magenta and Black, whereby it is possible to enhance the gradation of Yellow. This reason is that in printing machines such as electronic photographic machines or printers, the gradation is stabilized as the number of screen lines is smaller. In other words, the printing of dots become unstable as a distance between generated dots is smaller. Also, the printing of dots becomes stable and also it is possible to enhance factors influencing greatly the picture quality such as gradation and the graininess as a distance between dots is larger. Though it is conceivable that the resolution is reduced by decreasing the number of screen lines of Yellow, this does not become the large factor of degradation if the lowness of the resolution of visual system of a human being is taken into consideration.

In addition, although it might be worried that the interference fringe called Moire is generated by changing the number of screen lines to apply the resultant number of screen lines to each of color components, it is possible to suppress the generation of Moire since the period of the screen of Yellow is set to the period which is double that of each of other color components.

As set forth hereinabove, according to the various aspects of the present invention, in the binarization processing for an image constituted by a plurality of color components, the numbers of screen lines optimal for respective color components are applied thereto, whereby it is possible to enhance the picture quality. It is needless to say apparent that those skilled in the art may make various modification of or changes to the above without departing from the spirit and scope of the present invention.

What is claimed is:

1. An image processing method comprising steps of:
scanning a color image of plural color components of multi-gradation;
executing a binarization processing of the scanned color image to generate a binary image through a pseudo-halftone processing; and
making the generated binary image of that of a screen configuration of a halftone dot configuration, wherein the number of screen lines of at least one of the plural color components constituting the image after the binarization processing is different from that of each of other color components.

2. An image processing method according to claim 1, wherein the number of screen lines of the color component which is different from that of each of other color components in the plurality of color components has a period in a main scanning direction which is equal to that of the number of screen lines of each of other color components.

3. An image processing method according to claim 1, wherein the number of screen lines of the color component which is different from that of each of other color components in the plurality of color components has a period in a sub-scanning direction which is equal to that of the number of screen lines of each of other color components.

4. An image processing method according to claim 1, wherein the number of screen lines of the color component which is different from that of each of other color components in the plurality of color components has screen periods in both a main scanning and sub-scanning directions which are double those of the number of screen lines of each of other color components.

5. An image processing method according to claim 2, wherein a threshold matrix used to generate the screen of the color component having the number of screen lines different from that of each of other color components in the plurality of color components is generated by enlarging twice each of threshold matrixes used to generate screens of other color components in the sub-scanning direction through a simple interpolation.

6. An image processing method according to claim 3, wherein a threshold matrix used to generate the screen of the color component having the number of screen lines different from that of each of other color components in the plurality of color components is generated by enlarging twice each of threshold matrixes used to generate screens of other color components in the main scanning direction through a simple interpolation.

7. An image processing method according to claim 4, wherein a threshold matrix used to generate the screen of the color component having the number of screen lines different from that of each of other color components in the plurality of color components is generated by enlarging twice each of threshold matrixes used to generate screens of other color components in both the main scanning and sub-scanning directions through a simple interpolation.

8. An image processing apparatus comprising:
means for scanning a color image of plural color components of multi-gradation;
means for executing a binarization processing of the scanned color image to generate a binary image through a pseudo-halftone processing; and
means for making the generated binary image of that of a screen configuration of a halftone dot configuration, wherein the number of screen lines of at least one of the plural color components constituting the image after the binarization processing is different from that of each of other color components.

9. An image processing apparatus according to claim 8, wherein the number of screen lines of the color component which is different from that of each of other color components in the plurality of color components has a period in a main scanning direction which is equal to that of the number of screen lines of each of other color components.

10. An image processing apparatus according to claim 8, wherein the number of screen lines of the color component which is different from that of each of other color components in the plurality of color components has a period in a sub-scanning direction which is equal to that of the number of screen lines of each of other color components.

11. An image processing apparatus according to claim 8, wherein the number of screen lines of the color component which is different from that of each of other color components in the plurality of color components has screen periods in both a main scanning and sub-scanning directions which are double those of the number of screen lines of each of other color components.

12. An image processing apparatus according to claim 9, wherein a threshold matrix used to generate the screen of the color component having the number of screen lines different from that of each of other color components in the plurality of color components is generated by enlarging twice each of threshold matrixes used to generate screens of other color components in the sub-scanning direction through the simple interpolation.

13. An image processing apparatus according to claim 10, wherein a threshold matrix used to generate the screen of the color component having the number of screen lines different from that of each of other color components in the plurality of color components is generated by enlarging twice each of threshold matrixes used to generate screens of other color components in the main scanning direction through the simple interpolation.

14. An image processing apparatus according to claim 11, wherein a threshold matrix used to generate the screen of the color component having the number of screen lines different from that of each of other color components in the plurality of color components is generated by enlarging twice each of threshold matrixes used to generate screens of other color components in both the main scanning and sub-scanning directions through the simple interpolation.
